(19) United States
(12) Patent Application Publication
(10) Pub. No.: US 2026/0290980 A1
(43) Pub. Date: Sep. 24, 2026

(54) BATTERY PACK COVER WITH A PROTRUDING DOUBLE WALL BATTERY DIVIDER AND THERMAL RUNAWAY BARRIER

(71) Applicant: SABIC GLOBAL TECHNOLOGIES B.V., Bergen op Zoom (NL)

(72) Inventors: Carlos PEREIRA CADENA, Putnam Valley, NY (US); Anil TIWARI, Maastricht (NL); Dinesh MUNJURULIMANA, Novi, MI (US); Zhongcai TONG, Shanghai (CN); Amol Prabhakar AVHAD, Bengaluru (IN); Han YAN, Shanghai (CN)

(21) Appl. No.: 19/484,561

(22) PCT Filed: May 21, 2024
(86) PCT No.: PCT/EP2024/063993

§ 371 Date: Nov. 14, 2025

Related U.S. Application Data
(60) Provisional application No. 63/503,514, filed on May 22, 2023.

(51) Int. Cl. H01M 50/262; B60L 50/64; H01M 50/249; H01M 50/258; H01M 50/278; H01M 50/289

(52) U.S. Cl. CPC H01M 50/262; B60L 50/64; H01M 50/249; H01M 50/258; H01M 50/278; H01M 50/289; H01M 2220/20

(57) ABSTRACT

An embodiment includes a cover for a battery pack for an electrical vehicle. It can include a cover base portion defining an edge perimeter sized to cover an opening of a housing subcomponent of the battery pack. The cover can have a base portion comprising a plurality of cover fastening features proximal to the edge perimeter defining a cover fastening perimeter. A battery divider can protrude from the cover base portion and extend past a plane generally defined the by the cover fastening perimeter. The battery divider can be formed by a plurality of walls. The plurality of walls can define a cover hollow that extends from a cover hollow base proximal the cover base portion to a cover hollow distal portion of the battery divider.

### TECHNICAL FIELD

The present subject matter relates to multi-cell battery packs, and more specifically to a battery pack cover with a double wall battery divider and thermal runaway barrier.

### BACKGROUND

Many of the covers made for electric vehicle battery packs are made using either steel, aluminum or thermoset materials such as sheet mold compounds (SMC). While these solutions offer good retention of mechanical properties over a wide range of temperature, and subsequently can withstand high pressure loads from inside of a battery pack during a thermal runaway, they also have to rely on additional thermal barriers to ensure that temperature of the non-exposed side of the cover are controlled within certain limits to ensure safety of occupants sitting inside the car. Another challenge with these solutions is that it is challenging to conceive structural ribs and features due to inherent manufacturing limitations.

Plastics offer high potential for constructing battery pack components. For example, they are lighter than metal, which can reduce energy consumption due to vehicle motion stop/start. Further, some plastics offer intumescence (i.e., the ability to form a black char layer similar to wood), which can increase their resistance to destruction under thermal anomaly. Additionally, a number of features can be molded into plastic parts, lowering battery pack cost.

While plastics offer these advantages, they also suffer some drawbacks versus metal. One drawback is that plastics can soften as they warm. If a battery pack cover is meant to contain combustion gasses, this softening could cause undesireable expansion of the battery pack. Solutions are needed that leverage the inherent potential of thermoplastics while managing their performance under thermal anomaly.

US20220294058A1 discloses a bottom composite cover (20) formed in a e. g compression or press mold [0053] at preferably low to moderate temperature and pressure [0054].

US20230231248A1 discloses crossbeams 112 formed of organosheet that are joined to a cover [0031] as part of a multi-material solution [0020].

US8835033B2 discloses a battery pack that uses a plastic housing to support the weight of the battery pack, wherein the composite extends to brackets.

JP2012018797A discloses case with a frame formed of ribs including reinforcing fiber to augment the load-carry capacity of the case.

DE 102017217155A1 discloses a battery housing with cell partitioning walls formed of continuous fiber reinforced plastic material to maintain cells in position in the housing.

WO2020200885A1 discloses a battery pack housing formed of thermoset plastic reinforced with continuous fibers.

### SUMMARY

To address the shortcoming described above, the present disclosure recognizes that introducing a patch of continuous-fiber lamina onto a cover changes its character while expanding, similar to applying a tape to a balloon. By affixing a patch to a cover, the nature of the expansion can be controlled within desirable limits, in a simple, low-cost manner that is feasible to manufacture. The patch can be circular, rectangular, or via a ribbon shape, as set forth herein.

The present disclosure also provide reinforcement structural ribs that enhance stiffness so that the resulting hybrid cover solution is strong enough to provide desired bending performance while withstanding relatively high pressure and high temperature in the event of a runaway within the battery pack.

The present subject matter provides structural ribbing in the form of a protruding battery divider that increases the potential to form intumescent layers between battery modules.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number can be used to indicate a similar feature or a feature with similar functionality, as may non-identical reference numbers.

FIG. 1A is a perspective view of a cover including a plurality of lamina patches, according to various examples.

FIG. 1B is a front view of the cover shown in FIG. 1A.

FIG. 2 is a schematic of a battery pack.

FIG. 3A is a perspective view of the top of a battery cover without reinforcement.

FIG. 3B is a perspective view of the bottom of the cover of FIG. 3B.

FIG. 4A is a perspective view of the top of a battery cover that is entirely reinforced.

FIG. 4B is a perspective view of the bottom of the cover of FIG. 4B.

FIG. 5A is a perspective view of the top of a battery cover that is partially reinforced.

FIG. 5B is a perspective view of the bottom of the cover of FIG. 5B.

FIG. 6A is a perspective view of the top of a battery cover that is partially reinforced.

FIG. 6B is a perspective view of the bottom of the cover of FIG. 6B.

FIG. 7 is a perspective view of the bottom of a battery cover that is partially reinforced, showing ribbing molded onto a reinforcement.

FIG. 8A shows deformation of the cover of FIGS. 3A-B under 38 kPa pressure. FIG. 8B shows that the cover of FIG. 8A under 50 kPa pressure.

FIG. 8C shows the degradation of stiffness of the cover of FIG. 8A under 38 kPa pressure.

FIG. 8C.1 is a close up of the section labeled FIG. 8C.1 in FIG. 8C.

FIG. 8D shows that the cover of FIG. 8A under 50 kPa pressure.

FIG. 9A shows deformation of the cover of FIGS. 4A-B under 38 kPa pressure. FIG. 9B shows that the cover of FIG. 9A under 50 kPa pressure.

FIG. 9C shows the degradation of stiffness of the cover of FIG. 9A under 38 kPa pressure.

FIG. 9D shows the degradation of stiffness of the cover of FIG. 9A under 50 kPa pressure.

FIG. 9D.1 is a close up of the section labeled FIG. 9D.1 in FIG. 9D.

FIG. 10A shows deformation of the cover of FIGS. 5A-B under 38 kPa pressure.

FIG. 10B shows that the cover of FIG. 10A under 50 kPa pressure.

FIG. 10C shows the degradation of stiffness of the cover of FIG. 10A under 38 kPa pressure.

FIG. 10D shows the degradation of stiffness of the cover of FIG. 10A under 50 kPa pressure.

FIG. 10D.1 is a close up of the section labeled FIG. 10D.1 in FIG. 10D.

FIG. 11A shows deformation of the cover of FIGS. 6A-B under 38 kPa pressure.

FIG. 11B shows that the cover of FIG. 11A under 50 kPa pressure.

FIG. 11C shows the degradation of stiffness of the cover of FIG. 11A under 38 kPa pressure.

FIG. 11D shows the degradation of stiffness of the cover of FIG. 11A under 50 kPa pressure.

FIG. 11D.1 is a close up of the section labeled FIG. 11D.1 in FIG. 11D.

FIG. 12A shows deformation of the cover of FIG. 7 under 38 kPa pressure.

FIG. 12B shows that the cover of FIG. 12A under 50 kPa pressure.

FIG. 12C shows the degradation of stiffness of the cover of FIG. 12A under 38 kPa pressure.

FIG. 12C.1 is a close up of the section labeled FIG. 12C.1 in FIG. 12C.

FIG. 12D shows the degradation of stiffness of the cover of FIG. 12A under 50 kPa pressure.

FIG. 12D.1 is a close up of the section labeled FIG. 12D.1 in FIG. 12D.

FIG. 13 is a perspective view of a flame resistant battery divider cover, according to some examples.

FIG. 14 is a perspective view of the flame resistant battery divider of FIG. 13, together with two battery modules, according to some examples.

FIG. 15 is an exploded view of a flame resistant battery divider cover, two battery modules, a cooling plate and a battery tray, according to some examples.

### DETAILED DESCRIPTION

One challenge to bringing plastic housing covers to market is the sheer size of the part. Injection molding is well-suited to small components, but large components, such as a cover for a battery pack, are difficult to manufacture, requiring special tooling. This can be addressed with modern manufacturing techniques, such as inject-compression molding, thermoforming, rotomolding, etc., but challenges remain. For example, for a top cover often there is relatively low requirement for structural integrity, as the cover supports little weight—mostly its own weight. Thus, to enjoy the benefits of lightweighting, the cover should be relatively thin. However, in some battery pack designs, there is a requirement to constrain back pressure/burst pressure and/or sag, such as during a thermal anomaly, or even during various changes to climate, pressure, etc. There are other needs a well, such as the need to tune the pack to have certain noise characteristics. One approach to addressing these needs is to make the cover composite, reinforced by continuous fibers. However, this introduces other challenges. Composites are known to be difficult to manufacture because the fibers much less malleable than the matrix materials (e.g. thermoplastic) in which they're disposed. For example, molding a sheet of fiber-reinforced material into a non-planar part can result in crumpling in corners.

To address these challenges, the present inventors have used composites in a specific way. By disposing composite sections or “patches” into the cover, it has been discovered that the expansion of the cover can be controlled within desired limits, enabling a battery pack to maintain pressure and control burst pressure and/or sag. Resisting bursting below a threshold or resisting sagging can decrease the rate at which thermal anomaly spreads in a battery pack, such as by limiting the ingress of oxygen from the atmosphere or providing for a controlled burst event. It can also protect the remainder of the vehicle from the impact of the thermal anomaly, such as by preserving the ability of char to form, which can resist heat transfer. Added benefits include being able to tune the deformation characteristics of the cover, and even tune the cover to provide desired vibrational behavior.

An objective of the present subject matter is to provide a thermoplastic hybrid battery cover solution with reinforced continues fiber composite laminates either locally or globally along the outer or inner surface of the thermoplastic solution. An objective is to provide a thermoplastic cover with integrated structural ribs inside or outside of the cover based on the packaging space available in the vehicle and battery pack architecture. An objective is to provide a hybrid thermoplastic solution via common manufacturing methods such as injection molding, compression molding and thermoforming. Several exemplary combinations are shown.

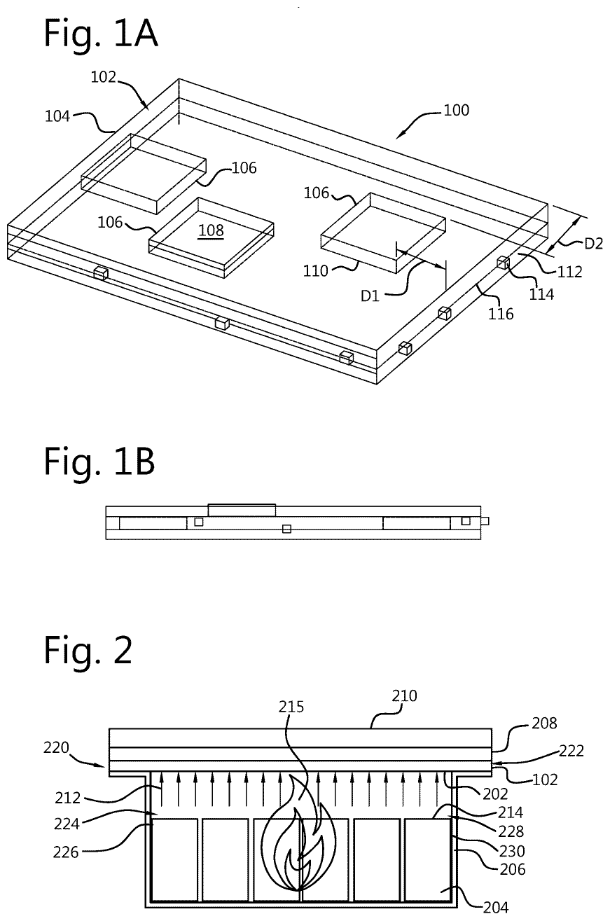

FIGS. 1A-B show a simplified example of the present subject matter. A cover 102 for a battery pack 100 for an electrical vehicle is shown. The battery pack can take the form shown in FIG. 2. The cover 102 can be a top cover. The cover 102 can include a plastic lamina 104. The cover 102 can include a reinforcement lamina 106 coupled to the plastic lamina 104. The plastic lamina 104 can be bonded or fused to the reinforcement lamina 106. The reinforcement lamina 106 can be insert molded into the cover 102, or otherwise fused to the plastic lamina 104 in a molding operation. The reinforcement lamina 106 can be laminated to the plastic lamina 104. The reinforcement lamina 106 can be adhered to the plastic lamina 104. The lamina can be fused by any suitable means, such as an adhesive or one of vibration welding, ultrasonic welding, infrared (IR) welding, hot plate welding, laser welding, and thermal welding. The reinforcement lamina 106 can be integrally formed during the molding of the cover 102. The reinforcement lamina 106 can be cut into appropriate sizes as desired, and may then be disposed on the bottom of the cover 102 in a single layer or in multiple layers, respectively. The reinforcement lamina 106 can be buried in the cover 102, or can be attached to the surface. The reinforcement lamina 106 can be disposed on the upper surface (outer surface), the undersurface, or both upper surface and undersurface of the cover 102. To install the reinforcement lamina 106, the reinforcement lamina 106 can be cut to appropriate size. The reinforcement lamina 106 can be stacked in a single or multiple layers and preheated. The reinforcement lamina 106 can be placed or mounted on desired locations of a mold of the cover 102. The cover 102 can be molded by an extrusion-compression molding apparatus or the like. When a high-temperature fiber reinforced composite transferred as a material of the cover 102 is disposed in the mold for extrusion molding, the cover 102 can be integrally formed with the reinforcement lamina 106 without a separate subsequent process.

The reinforcement lamina 106 can be a continuous-fiber reinforced composite lamina, as discussed further herein. The reinforcement lamina 106 can be a patch.

Although three reinforcement lamina 106 are shown, there can be as little as one or more than three. Further, although the three reinforcement lamina 106 are shown as having a quadrilateral shape with an upper major surface 108 and a lower major surface 110 opposite the upper major surface 108, other shapes can be used, such as ellipses, ribbons, etc. The reinforcement lamina 106 can span less than the entire plastic lamina 104.

The plastic lamina can define an edge perimeter 112. The edge perimeter 112 can be sized to cover an opening of a housing subcomponent of a battery pack (see, e.g. FIG. 2 opening 202). The plastic lamina 104 can include one or more fastening features 114. The one or more fastening features 114 can be proximal to the edge perimeter 112 and can define a cover fastening perimeter 116. A border region D1 and/or D2 of the plastic lamina 104 can be defined between one or both of the edge perimeter 112 and the fastening perimeter 116 and the reinforcement lamina 106. The border region of the plastic lamina 104 can surround a reinforcement lamina 106. the reinforcement lamina 106 can be spaced apart from the edge perimeter 112.

FIG. 2 is a schematic of a battery pack. The battery pack can include a housing subcomponent 206. One or more cells 204 can be disposed in the housing subcomponent. The cover 102 can cover an opening 202 in the housing subcomponent 206. The cover 102 can cover cells 204 disposed in the housing subcomponent. Battery cells of a battery pack can be arranged in a cluster defining a planar face 214. Referring to FIG. 1A and FIG. 1B, a cover 102 can be dimensioned to substantially cover 102 the planar face, the cover 102 having a proximal portion 220 and a distal portion 222, the cover 102 dimensioned such that a distance between the proximal portion 220 and the distal portion 222 can be sized to extend from a first location 224 proximal a first edge 226 of the planar face 214, across the planar face 214, to a second location 228 proximal a second edge 230 of the planar face 214 that can be opposite the first edge 226 of the planar face 214.

The top cover can have a bending stress that is lower than the housing subcomponent 206. The bending stress can measured across an axis bisecting the components. The bending stress can measured across an axis that can pass through or over/under a center of gravity of the component, in an example. An option additional cover 208 can be used, such as a noise control or added thermal barrier. The optional additional cover 208 can be metal. The battery pack can be mated to a vehicle portion 210, such as a floor, which it can abut or be disposed adjacent to.

Representations of pressure 212 and thermal anomoly 215 are depicted. The pressure can be positive or negative versus pack ambient pressure, although it is shown positive. The cover 102 can be an anisotropically expanding cover, meaning that as it expands, different portions expand at different rates of expansion.

As discussed above, the cover 102 can include a lamina, such as a reinforcement lamina, also referred to as plies. The reinforcement lamina 106 can be coupled to an interior of the cover. The reinforcement lamina 106 can be coupled to an exterior of the cover. The reinforcement lamina 106 spans less than the entire plastic lamina 104. The reinforcement lamina 106 can be framed by the plastic lamina 104.

Such a lamina can-but need not-include fibers. If included, the fibers can comprise fibers having one or more of the present compositions (e.g., made by passing the composition(s)—either melted or dissolved in a solvent-through a spinneret), carbon fibers, glass fibers, aramid fibers, ceramic fibers, basalt fibers, volcanic ash fibers, natural fibers, and/or the like. In some such laminae, the fibers can be dispersed within a matrix material comprising, for example, one or more of the present compositions, a thermoplastic material, and/or a thermoset material.

The fibers in such a lamina can be arranged in any suitable fashion. To illustrate, the fibers can be aligned in a single direction. For example, the lamina can be unidirectional (e.g., a unidirectional tape). The fibers can be arranged in a woven configuration, such as in a plane, twill, satin, basket, leno, mock leno, or the like weave. The lamina can be non-woven (e.g., dry-laid, wet-laid, spunmelt, or the like), in which the fibers are multi-directional, arranged in a sheet or web, and connected to one another via entanglement and/or thermal and/or chemical bonds rather than in a weave or knit. The unidirectional tape can have an arrangement in which many strands of continuous fiber longitudinally extend in the same direction (strand arrangement), and the continuous fiber fabric can have a woven structure in which the continuous fibers cross each other in the longitudinal and latitudinal directions. The continuous fiber of a unidirectional (UD) or woven type can be used. Some examples of the woven type may include plain, twill, and satin types woven at 0°/90° and a type woven at 0°/90°/−45°/45°. When the reinforcement lamina in which the continuous fiber is arranged in one direction is used (for example, the unidirectional tape is used as a fiber reinforced material), the continuous fibers in the reinforcement lamina can be arranged in a “crossing direction” with respect to the forward and backward longitudinal direction of the cover (i.e., the continuous fibers in the reinforcement lamina can be arranged in the right and left width direction with respect to the forward and backward longitudinal direction of the cover).

The cover 102 and the reinforcement lamina 106 can be manufactured using the unidirectional tape or the continuous fiber fabric described above. Accordingly, the cover 102 and the reinforcement lamina 106 can be manufactured such that the continuous fiber in the plastic matrix can be arranged in one direction or fixed in a form of a woven fiber.

As stated, some laminae comprising one or more of the present compositions may not include fibers; for example, such a lamina can comprise a sheet or film of those composition(s). Laminates, which can include any two or more of the laminae described above arranged in any suitable layup (e.g., asymmetric or symmetric), are also disclosed.

The present compositions can also be included in skin-core (e.g., sandwich, ABA, and the like) composites, in which relatively-when compared to the core-thin and stiff skin(s) are disposed on one or both sides of a relatively-when compared to the skin(s)-thick and low-density core. By way of example, the core can include foam (e.g., open-or closed-cell), a honeycomb structure, balsa wood, and/or the like, and the skin(s) can include fiber-reinforced laminate(s). Such a skin-core composite can comprise one or more of the present compositions in that its skin(s) can include one or more of any of the laminae and laminates described above and/or its core can comprise one or more of the present compositions.

Molding materials that include one or more of the present compositions, suitable for use in, for example, injection molding and/or compression molding, can be used. Such molding material can be provided as pellets. The disclosed molding materials can include a filler, such as talc, calcium carbonate, discontinuous or short fibers (e.g., including any of the fiber-types described above), and/or the like.

The present compositions can be included in articles. To illustrate, such an article can comprise one or more of any of the laminae, laminates, and skin-core composites described above and/or any of the molding materials described above. In such an article including one or more laminae, laminates, and/or skin-core composites, the lamina(e), laminate(s), and/or skin-core composite(s) can be bonded to a molding material via overmolding, compression molding, and/or the like. The present compositions can have sufficiently high RF-transparencies to render them particularly suitable for use in articles in which RF-transparency is desirable.

A cover can be manufactured by an extrusion-compression molding method using a fiber-reinforced plastic composite to reduce the weight. A long fiber with an aspect ratio (i.e., Length by Diameter (L/D)) of about 1,000 or more or a continuous fiber (i.e., a fiber without a break therein) can be used to improve the structural stiffness, the collision characteristics, and the dimensional stability of the case.

When the cover 102 is press-formed using the fiber reinforced thermoplastic composite containing the reinforcing fiber, the cover 102 can be formed such that the length of remaining or residual reinforcing fiber is such that it provides the fiber with an aspect ratio of about 1,000 or more, at least on average. When the aspect ratio of the remaining or residual reinforcing fiber is less than about 1,000, a sufficient stiffness reinforcing effect may not be achieved. The aspect ratio of the remaining reinforcing fiber may range from about 1,000 to about 10,000.

Generally, the dimensional stability of parts can be directly affected by the shape of the parts, but can be improved by the proper selection of materials and forming methods. Thus, according to various embodiments, the fiber reinforced plastic composite case can be manufactured by an extrusion-compression molding method that can minimize a residual stress caused by a shear force during the product molding.

According to various embodiments, when manufacturing the cover 102, the long fiber may account for about 30 wt % to about 70 wt % of the total weight of the plastic composite used in forming the cover 102. When the weight of the long fiber is less than about 30 wt %, desired mechanical characteristics may not be achieved. On the other hand, when the weight of the long fiber is greater than about 70 wt %, the flowability can be reduced during the molding, causing reduction of moldability and deterioration of the exterior quality.

When the fiber reinforced plastic composite cover 102 is manufactured, the long fiber and the continuous fiber can be blended and used as a reinforcing fiber. In particular, a continuous fiber type of reinforcing fiber can be blended with the long fiber. The continuous fiber can be applied to the whole region of the cover 102 (i.e. throughout the cover 102). The continuous fiber can be locally applied only to one or more portions where high stiffness is desired. The continuous fiber can be partially applied only to portions of the cover 102 at which typical structure-reinforcing members, such as cross members, side members, and mounting brackets, are disposed, or to portions of the cover 102 coupled to the vehicle body through bolting and the like. When the continuous fiber is locally applied, typical structure-reinforcing members can be formed integrally with the case placement of the continuous fiber.

Thus the reinforcement lamina 106 can be a continuous-fiber reinforced composite lamina coupled to the plastic lamina. The reinforcement lamina 106 can be formed of a unidirectional tape. The unidirectional tape can include continuous fibers disposed in a thermoplastic matrix. The unidirectional tape can include continuous fibers disposed in parallel. The reinforcement lamina 106 can be formed of a woven. The cover 102 can include a plastic lamina 104. The plastic lamina can be formed of a monolithic thermoplastic. The plastic lamina 104 can be formed of a chopped long-glass fiber reinforced thermoplastic with a matrix material. The matrix material of any of the lamina, or the housing subcomponent, can be formed of various materials. The plastic matrixes of these components can be identical to or different from each other. When an identical plastic matrix is used, the interfacial bonding strength between different kinds of parts can be improved.

The matrix material can be formed of a polymeric composition comprising a thermoplastic polymer. The thermoplastic polymer is not particularly limited and can include at least one of a polyacetal, a polyacrylic, a polycarbonate, a polystyrene, a polyester, a polyamide, a polyamideimide, a polyarylate, a polyarylsulfone, a polyethersulfone, a polyphenylene sulfide, a polysulfone, a polyimide, a polyetherimide, a fluoropolymer (for example, polytetrafluoroethylene), a polyetherketone, a polyether ether ketone, a polyether ketone ketone, a polybenzoxazole, a polyoxadiazole, a polybenzimidazole, a polyacetal, a polyanhydride, a poly(vinyl ether), a poly(vinyl thioether), a poly(vinyl alcohol), a poly(vinyl ketone), a poly(vinyl halide), a poly(vinyl nitrile), a poly(vinyl ester), a polysulfonate, a polysulfide, a polysulfonamide, a polyurea, or a polyphosphazene. The thermoplastic polymer can include a polyolefin, a polycarbonate, a polysulfone, a polyetherimide, a polyamide, a polyester (for example, poly(ethylene terephthalate) or poly(butylene terephthalate), a polystyrene, a polyether (for example, a polyether ketone or a polyether ether ketone), or a polyacrylate (for example, poly(methyl methacrylate).

The thermoplastic polymer can comprise a polyolefin. The polyolefin comprises at least one of a homopolymer or a copolymer. The polyolefin can be of the general structure: CnH 2n, where n can be 2 to 20. The polyolefin can include at least one of a polyethylene, a polypropylene, a polyisobutylene, or a polynorbornene. Examples of polyethylene include linear low density polyethylene (LLDPE), high density polyethylene (HDPE), and medium density polyethylene (MDPE). The polyolefin can include a polyolefin copolymer, for example, copolymers of ethylene and at least one of propene, 1-butene, 1-octene, 1-decene, 4-methylpentene-1, 2-butene, 1-pentene, 2-pentene, 1-hexene, 2-hexene, 3-hexene, norbornene, or a diene (for example, 1,4 hexadiene, monocylic or polycyclic dienes). The polyolefin copolymer can include a heterophasic polyolefin., the thermoplastic polymer can include a polyethylene.

The thermoplastic composition can include an additive. The additive can include at least one of a foaming agent, a flame retardant, an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, anti-drip agent (e.g., a PTFE-encapsulated styrene-acrylonitrile copolymer (TSAN)), or a combination thereof. For example, a combination of a heat stabilizer, mold release agent, and ultraviolet light stabilizer can be used. In general, the additives are used in the amounts generally known to be effective.

The thermoplastic composition can include a foaming agent that, e.g., foams at about 240° C. The presence of the foaming agent can function to absorb heat energy to potentially prevent thermal runaway or to prevent oxygen from contacting the surface of the polymer during combustion (intumescence). The foaming agent can include a solid foaming agent, a liquid foaming agent, or a supercritical foaming agent. The foaming agent can be a solid at room temperature and, when heated to temperatures higher than its decomposition temperature, generate a gas (for example, nitrogen, carbon dioxide, or ammonia gas), such as azodicarbonamide, metal salts of azodicarbonamide, 4,4′ oxybis(benzenesulfonylhydrazide), sodium bicarbonate, ammonium carbonate, or the like. The foaming agent can include at least one of an inorganic agent or an organic agents. Examples of inorganic blowing agents include carbon dioxide, nitrogen, argon, water, air, nitrogen, ammonia, and inert gases for example helium and argon. Examples of organic agents include aliphatic hydrocarbons having 1 to 9 carbon atoms, aliphatic alcohols having 1 to 3 carbon atoms, and fully and partially halogenated aliphatic hydrocarbons having 1 to 4 carbon atoms. Examples of aliphatic hydrocarbons include methane, ethane, propane, n-butane, isobutane, n-pentane, isopentane, neopentane, and the like.

Examples of aliphatic alcohols include methanol, ethanol, n-propanol, and isopropanol. Examples of fully and partially halogenated aliphatic hydrocarbons include fluorocarbons, chlorocarbons, and chlorofluorocarbons. Examples of fluorocarbons include methyl fluoride, perfluoromethane, ethyl fluoride, 1,1-difluoroethane, 1,1, 1-trifluoroethane, 1,1,1,2-tetrafluoro-ethane, pentafluoroethane, difluoromethane, perfluoroethane, 2,2-difluoropropane, 1,1, 1-trifluoropropane, perfluoropropane, dichloropropane, difluoropropane, perfluorobutane, perfluorocyclobutane, and the like. Examples of partially halogenated chlorocarbons and chlorofluorocarbons include methyl chloride, methylene chloride, ethyl chloride, 1,1, 1-trichloroethane, 1, 1-dichloro-1-fluoroethane, 1-chloro-1,1-difluoroethane, chlorodifluoromethane, 1,1-dichloro-2,2,2-trifluoroethane, 1-chloro-1,2,2,2-tetrafluoroethane, and the like. Examples of fully halogenated chlorofluorocarbons include trichloromonofluoromethane, dichlorodifluoromethane, trichlorotrifluoroethane, 1,1, 1-trifluoroethane, pentafluoroethane, dichlorotetrafluoroethane, chloroheptafluoropropane, and dichlorohexafluoropropane. Examples of other chemical agents include azodicarbonamide, azodiisobutyronitrile, benzenesulfonhydrazide, 4,4-oxybenzene sulfonyl-semicarbazide, p-toluene sulfonyl semi-carbazide, barium azodicarboxylate, N, N′-dimethyl-N, N′-dinitrosoterephthalamide, trihydrazino triazine, and the like.

A matrix material can include a flame retardant, such as, for example, a phosphate structure (e.g., resorcinol bis(diphenyl phosphate)), a sulfonated salt, halogen, phosphorous, talc, silica, a hydrated oxide, a brominated polymer, a chlorinated polymer, a phosphorated polymer, a nanoclay, an organoclay, a polyphosphonate, a poly[phosphonate-co-carbonate], a polytetrafluoroethylene and styrene-acrylonitrile copolymer, a polytetrafluoroethylene and methyl methacrylate copolymer, a polysilixane copolymer, and/or the like.

Examples of halogenated flame retardants include bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; and 2,2-bis-(3,5-dichloro-4-hydroxyphenyl)-propane 2,2 bis-(3-bromo-4-hydroxyphenyl)-propane. Other halogenated materials include 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, as well as oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant. When present, halogen containing flame retardants can be present in amounts of 1 to 25 parts by weight, or 2 to 20 parts by weight, based on 100 parts by weight of the total composition, excluding any filler.

Alternatively, the thermoplastic composition can be essentially free of chlorine and bromine. “Essentially free of chlorine and bromine” is defined as having a bromine or chlorine content of less than or equal to 100 parts per million by weight (ppm), less than or equal to 75 ppm, or less than or equal to 50 ppm, based on the total parts by weight of the composition, excluding any filler.

The flame retardant can comprise a phosphorus containing flame retardant. Flame retardant aromatic phosphates include triphenyl phosphate, tricresyl phosphate, isopropylated triphenyl phosphate, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, and 2-ethylhexyl diphenyl phosphate. Di-or polyfunctional aromatic phosphorus-containing compounds are also useful, for example resorcinol tetraphenyl diphosphate (RDP), the bis(diphenyl) phosphate of hydroquinone and the bis(diphenyl) phosphate of bisphenol A, respectively, and their oligomeric and polymeric counterparts. Flame retardant compounds containing phosphorus-nitrogen bonds include phosphonitrilic chloride, phosphorus ester amides, phosphoric acid amides, phosphonic acid amides, phosphinic acid amides, and tris(aziridinyl) phosphine oxide. The aromatic phosphate can include a di-or polyfunctional compound or polymer. When used, phosphorus-containing flame retardants can be present in amounts of 0.1 to 30 parts by weight, or 1 to 20 parts by weight, based on 100 parts by weight of the total composition, excluding any filler.

Inorganic flame retardants include salts of C1-16 alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate; salts such as Na2CO3, K2CO3, MgCO3, CaCO3, and BaCO3, or fluoro-anion complexes such as Li3AlF6, BaSiF6, KBF4, K3AlF6, KAlF4, K2SiF6, or Na3AlF6. When present, inorganic flame retardant salts can be present in amounts of 0.01 to 10 parts by weight, or 0.02 to 1 parts by weight, based on 100 parts by weight of the total composition, excluding any filler.

The thermoplastic composition can have a UL94 flame rating of VO or better at a non-limiting thickness of 3.5 millimeters (mm), preferably 2 mm, or 1.5 mm, or 1 mm, or less, as measured in accordance with the Underwriter's Laboratory Bulletin 94 (UL94) entitled “Tests for Flammability of Plastic Materials for Parts in Devices and Appliances” (ISBN 0-7629-0082-2), Fifth Edition, Dated Oct. 29, 1996, incorporating revisions through and including Dec. 12, 2003.

A matrix material can include one or more additives, such as, for example, a coupling agent to promote adhesion between the matrix material and fibers of the unidirectional tape, an antioxidant, a heat stabilizer, a flow modifier, a stabilizer, a UV stabilizer, a UV absorber, an impact modifier, a cross-linking agent, a colorant, or a combination thereof. Non-limiting examples of a coupling agent include POLYBOND 3150 maleic anhydride grafted polypropylene, commercially available from DUPONT, FUSABOND P613 maleic anhydride grafted polypropylene, commercially available from DUPONT, maleic anhydride ethylene, or a combination thereof. A non-limiting example of a flow modifier is CR20P peroxide masterbatch, commercially available from POLYVEL INC. A non-limiting example of a heat stabilizer is IRGANOX B 225,commercially available from BASF. Non-limiting examples of UV stabilizers include hindered amine light stabilizers, hydroxybenzophenones, hydroxyphenyl benzotriazoles, cyanoacrylates, oxanilides, hydroxyphenyl triazines, and combinations thereof. Non-limiting examples of UV absorbers include 4-substituted-2-hydroxybenzophenones and their derivatives, aryl salicylates, monoesters of diphenols, such as resorcinol monobenzoate, 2-(2-hydroxyaryl)-benzotriazoles and their derivatives, 2-(2-hydroxyaryl)-1,3,5-triazines and their derivatives, or combinations thereof. Non-limiting examples of impact modifiers include Non-limiting examples of impact modifiers include elastomers/soft blocks dissolved in one or more matrix-forming monomers (e.g., bulk HIPS, bulk ABS, reactor modified PP, LOMOD, LEXAN EXL, and/or the like), thermoplastic elastomers dispersed in a matrix material by compounding (e.g., di-, tri-, and multiblock copolymers, (functionalized) olefin (co)polymers, and/or the like), pre-defined core-shell (substrate-graft) particles distributed in a matrix material by compounding (e.g., MBS, ABS-HRG, AA, ASA-XTW, SWIM, and/or the like), or combinations thereof. Non-limiting examples of cross-linking agents include include divinylbenzene, benzoyl peroxide, alkylenediol di(meth)acrylates (e.g., glycol bisacrylate and/or the like), alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, or combinations thereof. In some unidirectional tapes, such an additive can comprise neat polypropylene.

Returning to the above figures, a cover 102 for a battery pack for an electrical vehicle can include a plastic lamina 104 defining an edge perimeter sized to cover 102 an opening of a cell supporting housing subcomponent of the battery pack, the plastic lamina 104 comprising a plurality of cover 102 fastening features proximal to the edge perimeter defining a cover 102 fastening perimeter. The cover can include a reinforcement lamina 106 means coupled to the plastic lamina 104 covering a portion of the plastic lamina 104, the reinforcement lamina 106 means for controlling or increasing burst pressure strain of the cover 102 versus the plastic lamina 104 alone. The reinforcement lamina 106 means can be for controlling or increasing the burst pressure of the plastic lamina 104 above a specified burst pressure. The reinforcement lamina 106 means can have an insert edge framed by the edge perimeter of the plastic lamina 104

A reinforcement lamina 106 means can be thinner than a continuous fiber support insert means coupled to the battery pack for supporting the weight of the battery pack. A continuous-fiber reinforced composite lamina means can be a first continuous-fiber reinforced composite lamina means that spans the plastic lamina 104 longitudinally. A cover can include a second continuous-fiber reinforced composite lamina means that spans the lamina transversely, intersecting the first composite means. Lamina means can be selected and placed on the cover 102 to change the vibrational characteristics of the cover 102 to a desired performance.

A cover 102 for a battery pack for an electrical vehicle can include a plastic lamina 104 defining an edge perimeter sized to cover 102 an opening of a housing subcomponent of the battery pack, the plastic lamina 104 comprising a plurality of cover 102 fastening features proximal to the edge perimeter defining a cover 102 fastening perimeter. The cover can include a continuous-fiber reinforced composite lamina coupled to the plastic lamina 104. The housing subcomponent can include at least one load-bearing fastening feature pair with each member of the pair disposed on opposite sides of the housing subcomponent, the load-bearing fastening feature pair sized to bear the weight of the battery pack as mounted to the electrical vehicle. The continuous-fiber reinforced composite lamina can be disposed between the members of the load-bearing fastening feature pair.

A continuous-fiber reinforced composite lamina can be coupled to the plastic lamina 104, the continuous-fiber reinforced composite lamina disposed substantially within the cover 102 fastening perimeter, extending across the plastic lamina 104 along a width of the cover 102 fastening perimeter, less than the a distance between a first intersection of the width and the cover 102 fastening perimeter and a second intersection of the width and the cover 102 fastening perimeter.

A continuous-fiber reinforced composite lamina can be coupled to the plastic lamina 104 and defining a continuous-fiber reinforced composite lamina perimeter, the continuous-fiber reinforced composite lamina disposed substantially within the edge perimeter, the continuous-fiber reinforced composite lamina surrounded by the plastic lamina 104 and spaced apart from the edge perimeter along a majority of the continuous-fiber reinforced composite lamina perimeter. The continuous-fiber reinforced composite lamina spans less than the entire plastic lamina 104.

A continuous-fiber reinforced composite lamina can be coupled to the plastic lamina 104, wherein the housing subcomponent comprises at least one load-bearing fastening feature pair with each member of the pair disposed on opposite sides of the housing subcomponent, the load-bearing fastening feature pair sized to bear the weight of the battery pack as mounted to the electrical vehicle. Wherein the continuous-fiber reinforced composite lamina can be disposed between the members of the load-bearing fastening feature pair.

A continuous-fiber reinforced composite lamina means can be coupled to the plastic lamina 104 covering a portion of the plastic lamina 104 and having an insert edge framed by the edge perimeter of the plastic lamina 104, the continuous-fiber reinforced composite lamina means for constraining the plastic lamina 104 to expand anisotropically as an interior volume of the battery pack increases subject to a pressure differential with an exterior of the battery pack.

At least one continuous-fiber reinforced composite lamina patch can be coupled to the plastic lamina 104, disposed within the cover 102 fastening perimeter. The at least one continuous-fiber reinforced composite lamina patch can be one of a plurality of continuous-fiber reinforced composite lamina patches.

A cover 102 for a battery pack for an electrical vehicle can include a plastic lamina 104 defining an edge perimeter sized to cover 102 an opening of a housing subcomponent of the battery pack, the plastic lamina 104 comprising a plurality of cover 102 fastening features proximal to the edge perimeter defining a cover 102 fastening perimeter. A continuous-fiber reinforced composite lamina means can be coupled to the plastic lamina 104, the continuous-fiber reinforced composite lamina for spanning the cover 102 fastening perimeter to control or increase the burst pressure of the plastic lamina 104 above a specified burst pressure.

A battery pack for an electrical vehicle can include a cover 102 subcomponent and a bottom housing subcomponent, wherein to cover 102 includes a plastic lamina 104 defining an edge perimeter sized to cover 102 an opening of a housing subcomponent of the battery pack, the plastic lamina 104 comprising a plurality of fastening features proximal to the edge perimeter defining a fastening perimeter. A continuous-fiber reinforced composite lamina means can be coupled to the plastic lamina 104, the continuous-fiber reinforced composite lamina for spanning the fastening perimeter to control or increase the burst pressure of the plastic lamina 104 above a specified burst pressure. The bottom housing subcomponent can define an interior volume subdivided by at least one reinforcing member spanning a width of the bottom housing. The bending stiffness of the cover 102 subcomponent can be less than a bending stiffness of the bottom housing subcomponent.

A cover 102 for a battery pack for an electrical vehicle can include a plastic lamina 104 defining an edge perimeter sized to cover 102 an opening of a housing subcomponent of the battery pack, the plastic lamina 104 comprising a plurality of fastening features proximal to the edge perimeter defining a fastening perimeter. A continuous-fiber reinforced composite lamina can be coupled to the plastic lamina 104, the continuous-fiber reinforced composite lamina disposed substantially within the fastening perimeter, extending across the plastic lamina 104 along a width of the fastening perimeter, less than the a distance between a first intersection of the width and the fastening perimeter and a second intersection of the width and the fastening perimeter.

A continuous-fiber reinforced composite lamina means can be coupled to the plastic lamina 104, the continuous-fiber reinforced composite lamina means sized to cover 102 continuous-fiber reinforced composite lamina disposed substantially within the fastening perimeter, extending across the plastic lamina 104 along a width of the fastening perimeter, less than the a distance between a first intersection of the width and the fastening perimeter and a second intersection of the width and the fastening perimeter.

A cover 102 for an electric vehicle battery pack can include a plastic lamina 104 defining an edge perimeter sized to occlude an opening of the battery pack, the perimeter comprising a plurality of fastening features proximal to an edge of the perimeter defining a fastening perimeter. A continuous-fiber reinforced composite lamina coupled to the plastic lamina 104, the continuous-fiber filled disposed substantially within the fastening perimeter, extending across the plastic lamina 104 less than a width of the fastening perimeter.

### EXAMPLES

Certain examples show ribbing. The ribbing can be molded through a co-injection process, a multi-shot process, an overmolding process, or can be adhered to their underlying component. The ribs can be disposed at a certain interval, for example, a uniform or non-uniform interval. In the following examples, a cover having a dimension of length of about 1800 mm, width of about 1473 mm, and a height of about 45 mm is shown. The illustrated examples effectively replaces multi-material systems with a single composite hybrid system with up to 30% weight saving compared to a metallic system, and reduce several assembly complexities.

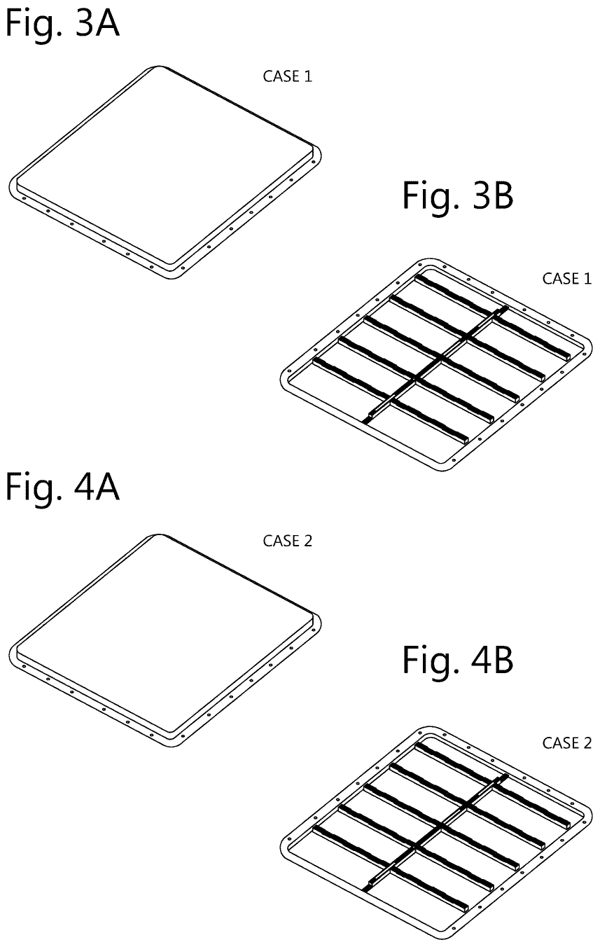

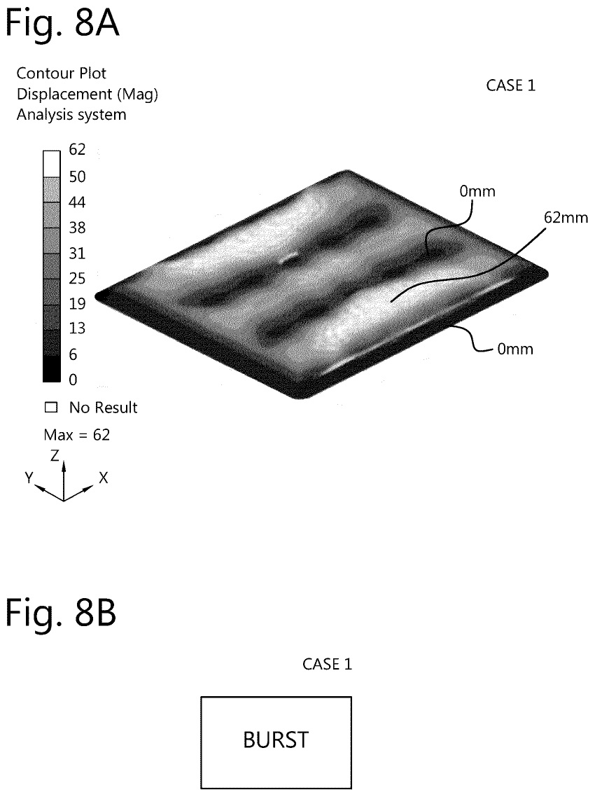

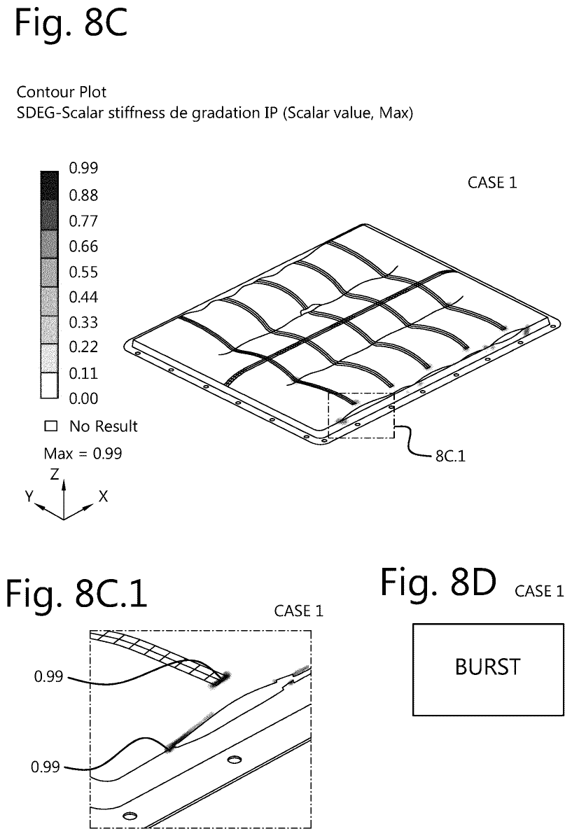

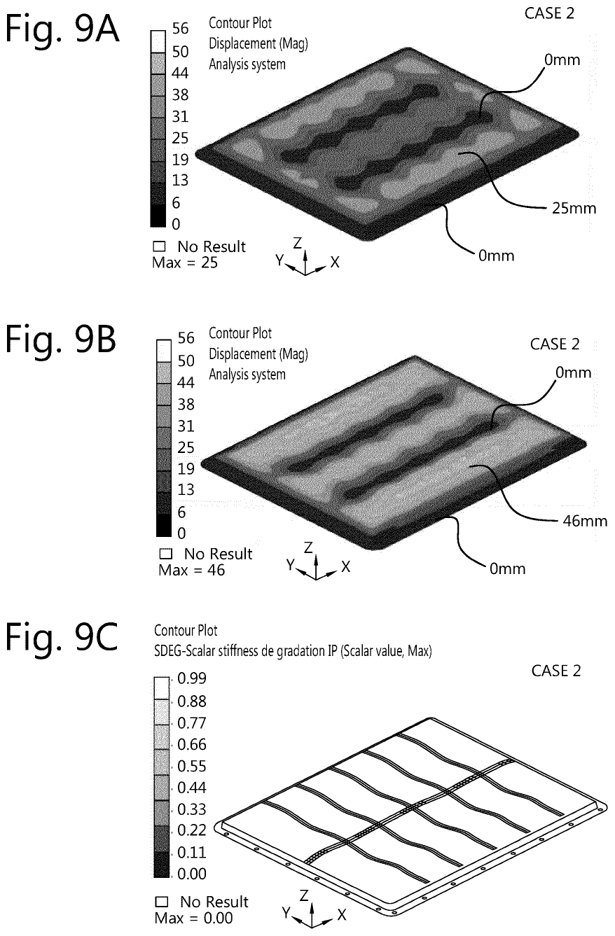

FIG. 3A is a perspective view of the top of a battery cover without reinforcement. The figures illustrate an all-plastic battery cover with integrated structural ribs. FIG. 3B is a perspective view of the bottom of the cover of FIG. 3B. FIGS. 3A-B correspond to CASE 1. CASE 1 depicts an all plastic design, without composite, having a thickness of 3.6 mm. FIG. 8A shows deformation of the cover of FIGS. 3A-B under 38 kPa pressure. FIG. 8B shows that the cover of FIG. 8A under 50 kPa pressure. FIG. 8C shows the degradation of stiffness of the cover of FIG. 8A under 38 kPa pressure. FIG. 8C.1 is a close up of the section labeled FIG. 8C.1 in FIG. 8C. FIG. 8D shows that the cover of FIG. 8A under 50 kPa pressure.

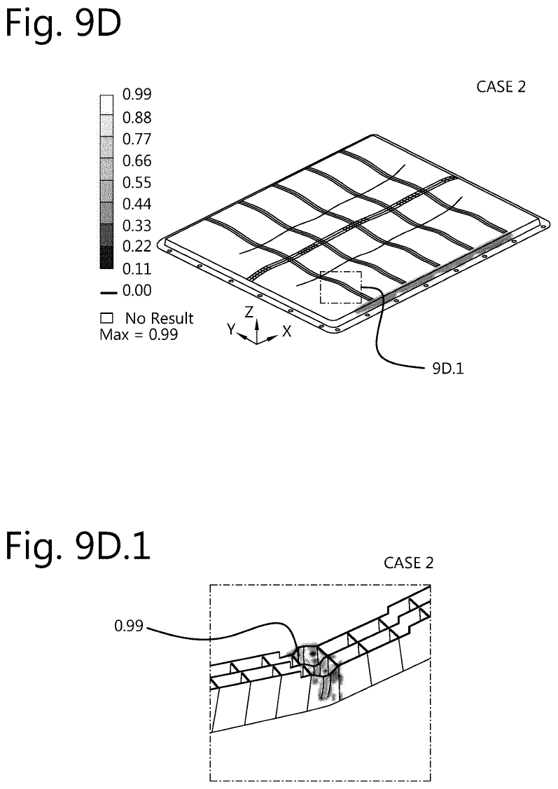

FIG. 4A is a perspective view of the top of a battery cover that is entirely reinforced. FIG. 4B is a perspective view of the bottom of the cover of FIG. 4B. The figures illustrate a composite hybrid battery cover with continues fiber laminates on top. The plastic lamina 104 can include a mat formed of polypropylene. FIGS. 4A-B correspond to CASE 2. CASE 2 depicts a plastic with composite, completely covered, with a plastic thickness of 2.5 mm and a composite thickness of 1.0 mm. FIG. 9A shows deformation of the cover of FIGS. 4A-B under 38 kPa pressure. FIG. 9B shows that the cover of FIG. 9A under 50 kPa pressure. FIG. 9C shows the degradation of stiffness of the cover of FIG. 9A under 38 kPa pressure. FIG. 9D shows the degradation of stiffness of the cover of FIG. 9A under 50 kPa pressure. FIG. 9D.1 is a close up of the section labeled FIG. 9D.1 in FIG. 9D.

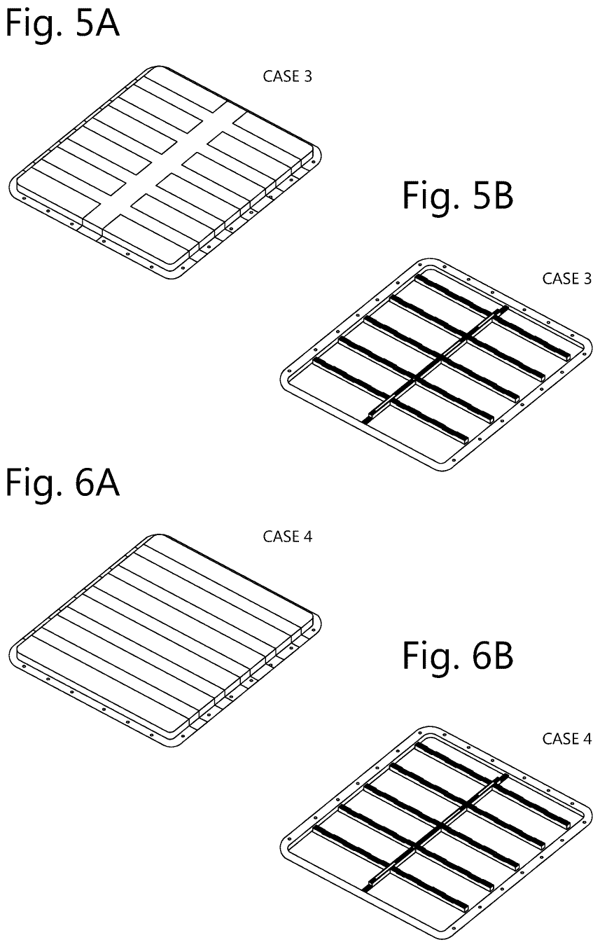

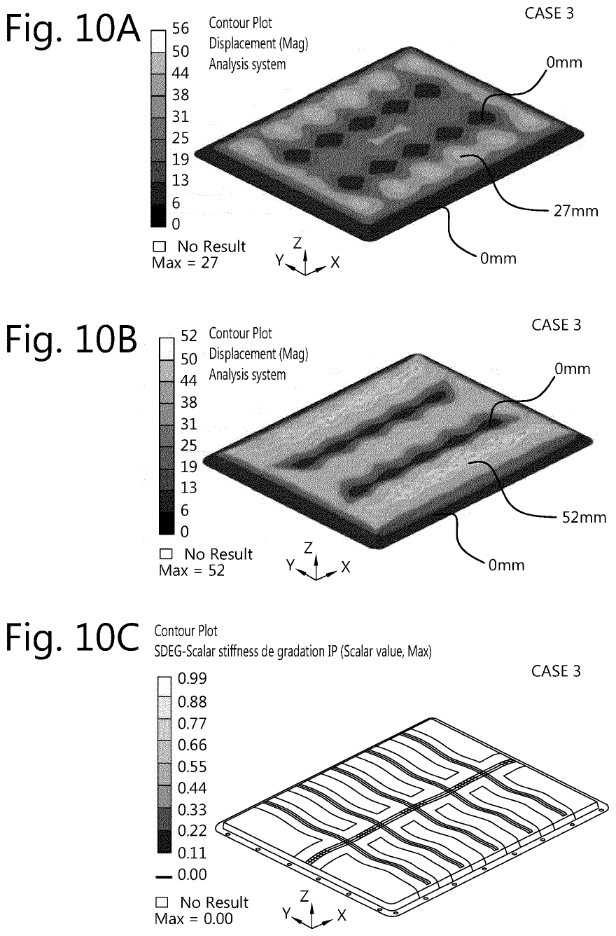

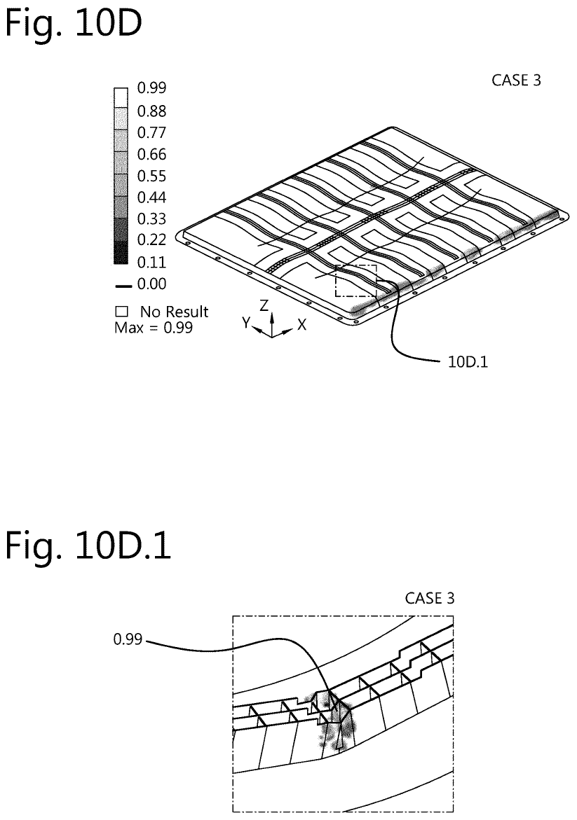

FIG. 5A is a perspective view of the top of a battery cover that is partially reinforced. FIG. 5B is a perspective view of the bottom of the cover of FIG. 5B. The figures illustrate a composite hybrid battery cover with continues fiber laminates on top only at locally stiffening area. FIGS. 5A-B correspond to CASE 3. CASE 3 depicts a plastic with composite, long and cross, with a plastic thickness of 3.5 mm, and a composite thickness 1.0 mm. FIG. 10A shows deformation of the cover of FIGS. 5A-B under 38 kPa pressure. FIG. 10B shows that the cover of FIG. 10A under 50 kPa pressure. FIG. 10C shows the degradation of stiffness of the cover of FIG. 10A under 38 kPa pressure. FIG. 10D shows the degradation of stiffness of the cover of FIG. 10A under 50 kPa pressure. FIG. 10D.1 is a close up of the section labeled FIG. 10D.1 in FIG. 10D.

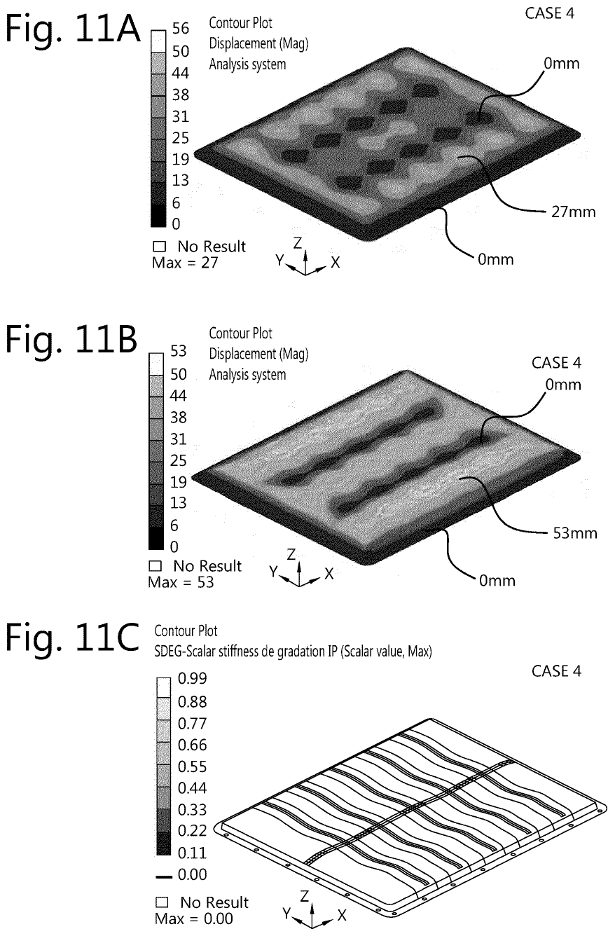

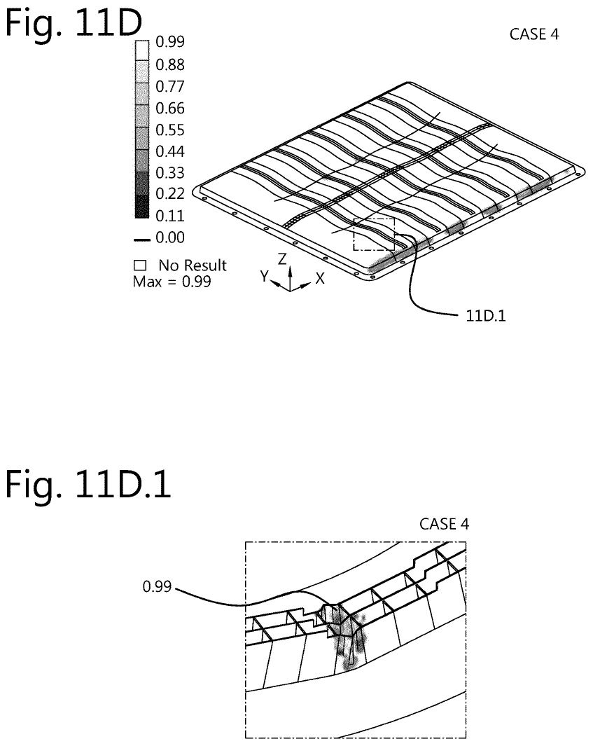

FIG. 6A is a perspective view of the top of a battery cover that is partially reinforced. FIG. 6B is a perspective view of the bottom of the cover of FIG. 6B. The figures illustrate a composite hybrid battery cover with continues fiber laminates on top only along the cross axis. FIGS. 6A-B correspond to CASE 4 depicts a plastic with composite, cross only, with a plastic thickness 2.5 mm and a composite thickness of 1.0 mm. FIG. 11A shows deformation of the cover of FIGS. 6A-B under 38 kPa pressure. FIG. 11B shows that the cover of FIG. 11A under 50 kPa pressure. FIG. 11C shows the degradation of stiffness of the cover of FIG. 11A under 38 kPa pressure. FIG. 11D shows the degradation of stiffness of the cover of FIG. 11A under 50 kPa pressure. FIG. 11D.1 is a close up of the section labeled FIG. 11D.1 in FIG. 11D.

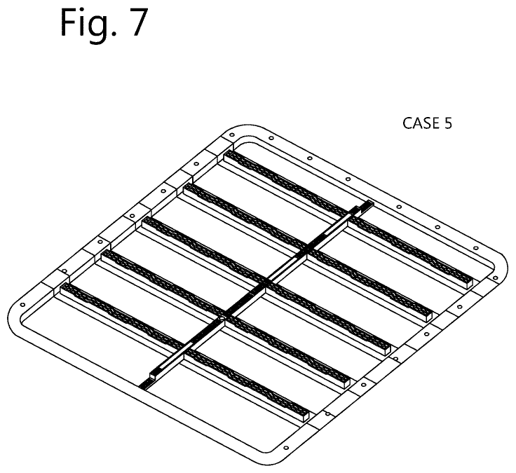

FIG. 7 is a perspective view of the bottom of a battery cover that is partially reinforced, showing ribbing molded onto a reinforcement. The figure illustrates a composite hybrid battery cover with continues fiber laminates on the bottom along a cross axis. FIG. 7 corresponds to CASE 5. CASE 5 depicts a plastic with composite, cross inside, with a plastic thickness 3.5 mm and a composite thickness of 1.0 mm.

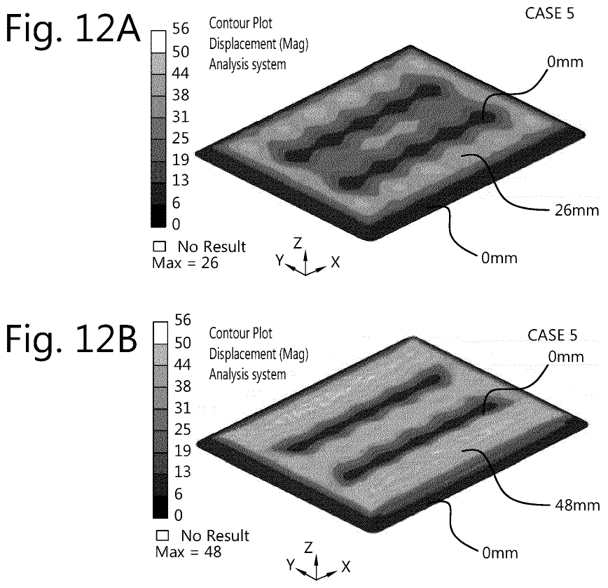

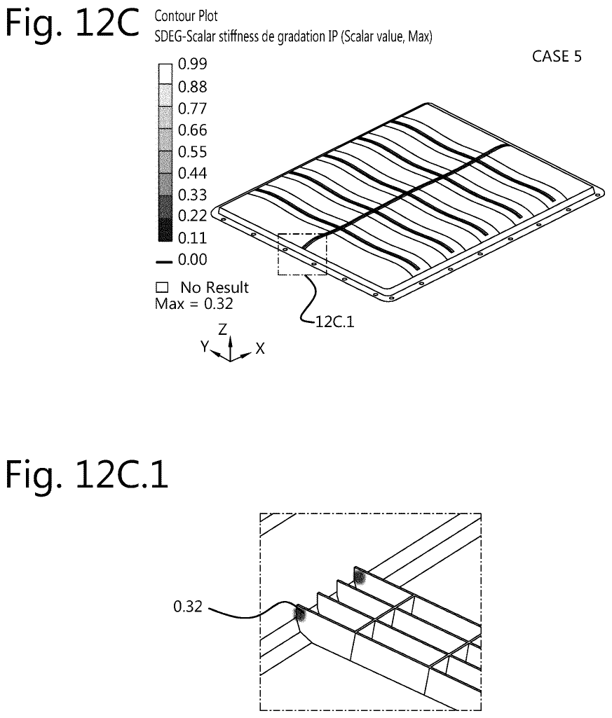

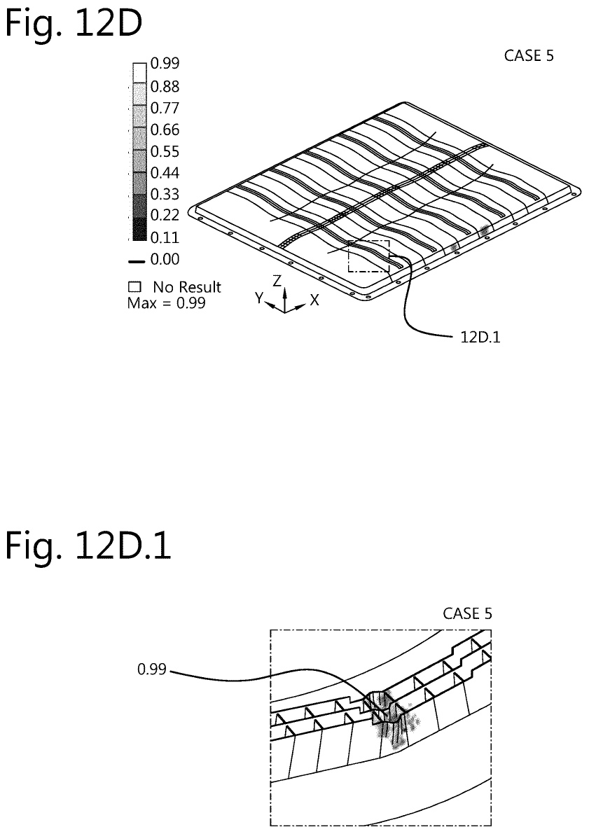

FIG. 12A shows deformation of the cover of FIG. 7 under 38 kPa pressure. FIG. 12B shows that the cover of FIG. 12A under 50 kPa pressure. FIG. 12C shows the degradation of stiffness of the cover of FIG. 12A under 38 kPa pressure. FIG. 12C.1 is a close up of the section labeled FIG. 12C.1 in FIG. 12C. FIG. 12D shows the degradation of stiffness of the cover of FIG. 12A under 50 kPa pressure. FIG. 12D.1 is a close up of the section labeled FIG. 12D.1 in FIG. 12D. Case 1 shows undesired bursting at certain selected pressures, while CASES 2-5 show that burst is controlled at certain selected pressures.

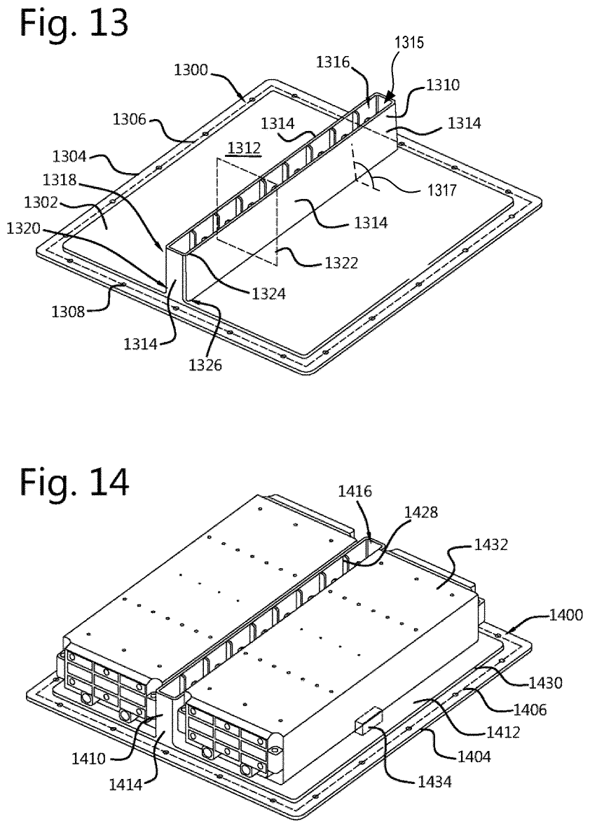

FIG. 13 is a perspective view of a flame resistant battery divider cover, according to some examples. The cover 1300 can be used for a battery pack for an electrical vehicle, but the present subject matter is not so limited, and can extend to battery packs for grid storage, aircraft, and the like. A cover base portion 1302 can define an edge perimeter 1304. The edge perimeter 1304 can be sized to cover an opening of a housing subcomponent of the battery pack. A housing subcomponent is sometimes referred to as a battery tray.

The cover base portion 1302 can include a plurality of cover fastening features 1308 proximal to the edge perimeter 1304 that can define a cover fastening perimeter 1306. A fastening feature can be a hole, a slot, a snap-fit feature, and the like. The cover base portion 1302 can be planar.

A battery divider 1310 can protrude or extend from the cover base portion 1302. The battery divider 1310 can be used to divide various battery pack components, such as battery, a battery management system or other electronics, a cooling apparatus, and the like. The battery divider 1310 can extend past a plane 1312 generally defined by the cover fastening perimeter 1306. The battery divider can be formed by a plurality of walls 1314. The plurality of walls 1314 can be continuous as shown, or the can be separate from one another or disjointed. The plurality of walls 1314 can define a cover hollow 1316. The cover hollow 1316 can extend from a cover hollow base 1320 proximal the cover base portion 1302 to a cover hollow distal portion 1318 of the battery divider 1310. The cover can define a distal opening 1315 that opens away from the cover hollow base 1320. The cover hollow distal portion 1318 can define the distal opening 1315. A cross-section 1322 of the battery divider 1310 taken generally perpendicular to the plane 1312 can be trapezoidal. A battery divider 1310 exterior draft angle 1317 can be characteristic of injection molding, e.g. 15 degrees or less from perpendicular to the plane 1312 toward the opening 1315. An interior draft angle opposite the exterior draft angle can mirror the exterior draft angle, e.g. 15 degrees or less from perpendicular to the plane 1312 away from the opening 1315. Thus the battery divider 1310 can include an battery divider interior injection molded draft angle and a battery divider exterior injection molded draft angle (e.g. 1317). The battery divider 1310 can define a battery divider base portion 1326 proximal the cover base portion 1302 that can be wider than a battery divider tip 1324 distal to the battery divider base portion 1326.

The cover base portion 1302 and the battery divider 1310 can be formed of a cover thermoplastic monolith. The cover 1300 can be made of any of the thermoplastics referenced herein. In some examples, the cover 1300 is made from polypropylene that includes a flame retardant and optionally glass filler. In some examples, such material is formed from pellets adapted to provide long-glass fiber. Examples include pellets around 8 mm in length used as raw material for an injection molding process. An example commercial product adapted for use as a material to form the cover 1300 is SABIC STAMAX with FR, which is a polypropylene containing a flame retardant and long glass fiber.

One benefit of the cover hollow 1316 is that it provides double the surfaces on which an intumescent layer can form during thermal runaway, thus reducing rates of flame propagation and/or thermal runaway. In such a scenario, an intumescent layer would first form on the exterior of the battery divider 1310, but could also form on an interior of the battery divider 1310. Flame propagation in such a construction could be one way across the battery divider 1310, or two ways. The presence of a cover hollow 1316 inside the battery divider 1310 can lead to an increase in the time the battery divider 1310 maintains structural integrity during thermal runaway. Another benefit of the battery divider 1310 as such is that it provides an air gap of high thermal insulation between portions of a battery pack, which can reduce heat radiation between cells, which can additionally reduce the rate of flame propagation and/or thermal runaway.

FIG. 14 is a perspective view of the flame resistant battery divider of FIG. 14, together with two battery modules, according to some examples. The plurality of walls 1414 can be adapted to physically secure at least one module 1432 of the battery pack against a housing subcomponent of the battery pack mateable to the cover 1400. For example, the plurality of walls can be of a thickness to manage loads in the x-y plane, substantially parallel to the plane 1412. To aid in such support, features can be disposed in the hollow. The cover 1400 can include one or more ribs 1428. The one or more ribs 1428 can be disposed in the cover hollow 1416 to support the plurality of walls 1414. Alternative or additional support can be provided such as foam, potting material, and the like, however a cover hollow 1416 without filler is more economical to manufacture and thus a preferred structure. In examples using foam or potting material, these fillers can include flame retardant. The battery divider 1410 can be smooth along an outer surface opposite the cover hollow 1416.

The cover defines a lip 1430 proximal the edge perimeter 1404. The lip 1430 can be interior to the cover fastening perimeter 1406. The lip 1430 can include a seal. The seal can be an adhesive, a gasket and the like. The lip 1430 can assist with aligning the cover 1400 to other components, such as a housing subcomponent. The cover 1400 can define a plurality of battery module locating features 1434 to constrain a plurality of battery modules 1432 with respect to the cover 1400.

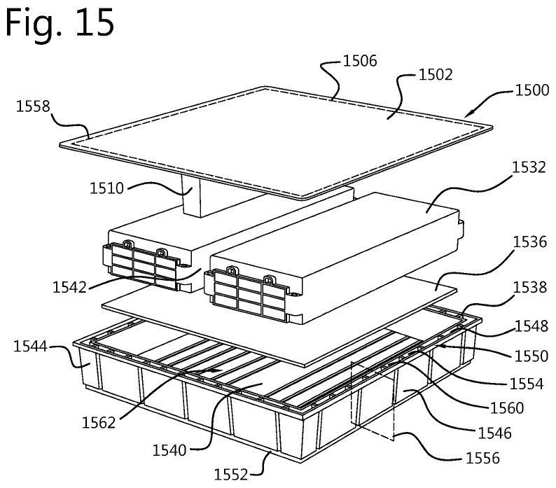

FIG. 15 is an exploded view of a flame resistant battery divider cover 1500, two battery modules 1532, a cooling plate 1536 and a housing subcomponent 1538, according to some examples. The cover 1500 can be a top cover to cover battery modules 1532 disposed in a housing subcomponent 1538 mateable to the cover 1500.

The housing subcomponent 1538 may be alternatively referred to as a battery tray. A battery tray can be constructed as a solid casing, made from light yet sturdy materials like aluminum or high-strength steel, designed to house the battery modules securely. Some recent advances also utilize composite materials to achieve better weight and strength optimization. Battery trays may incorporate measures for passive cooling, and in some designs, active thermal management systems are included to regulate battery temperature and extend battery cell lifespan. Battery trays may be designed with an emphasis on crash safety, absorbing impact and protecting the battery from damage during collisions. Some manufacturers have integrated the battery tray into the vehicle's body structure to add rigidity to the vehicle chassis, an approach known as skateboard design.

The cover 1500 can include a means for separating battery pack components, which can be the battery divider 1510 illustrated. The means for separating battery pack components can protrude from the cover base portion 1502 and for extending through a housing subcomponent 1538. The cover 1500 can be mateable to the housing subcomponent 1538. When mated, the cover 1500 and the housing subcomponent 1538 can define a cavity 1562. In some examples the battery divider 1510 cab extend to a bottom floor 1540 of the housing subcomponent 1538. The battery divider 1510 can define an air gap 1542 between two battery pack components.

The battery divider can be used as a means for wedging between two battery pack components, such as battery modules 1532, pressing them against a housing subcomponent 1538. The cover 1500 and/or the divider 1510 can be used for separating battery pack components, such as battery modules 1532, physically securing at least one module of the battery pack against a housing subcomponent 1538 of the battery pack. The cover 1500 can include lip means, such as the lip disclosed herein, for locating the cover 1500 with respect to a housing subcomponent 1538 mateable to the cover 1500, for aligning cover fastener passages 1558, such as cover fastening features 1308, and housing subcomponent passages 1560, such as a threaded bolt hole or similar passage for a fastener.

The housing subcomponent 1538 can include a plurality of upstanding walls 1544 extending from the housing subcomponent base portion 1546 to a housing opening perimeter 1548 to which the cover 1500 can be coupled along the cover fastening perimeter 1506. At least one of the plurality of upstanding walls 1544 can define a housing subcomponent hollow 1550 extending from a housing subcomponent hollow base 1552 proximal the housing subcomponent base portion 1546 to an housing subcomponent hollow opening 1554 proximal the housing opening perimeter 1548. The housing subcomponent base portion 1546 and the plurality of upstanding walls 1544 can be formed of a housing thermoplastic monolith.

The housing subcomponent hollow 1550 can define a substantially trapezoidal shape in cross-section 1556. The housing subcomponent cross-sectional thickness can be greater than a cover cross-sectional thickness. The cover 1500 can have a bending stress that can be lower than the housing subcomponent 1538.

Various parts disclosed herein, including covers 1300, 1400, or 1500 can be formed using injection molding. Such parts can be formed using single-shot injection molding, resulting in a unitary or monolithic part formed of thermoplastic. As referenced above, such parts can be formed of long-glass fiber molded in a single shot. The dividers, e.g. dividers 1310, 1410 or 1510 can demonstrate draft angles characteristic of injection molding.

As used herein, the term “unitary,” “monolith,” or “monolithic,” for example, a unitary component or a monolith or monolithic structure, refers to a construction, e.g., one body or single construction. The construction can be formed from portions that are chemically bonded in the construction and which can have substantially identical or identical compositions. Accordingly, a unitary component differs from a laminate or assembly of differing constituents, which includes an interface between differing constituents thereof. A unitary component can be integrally formed, for example, integrally molded in a single mold. Integral formation of a unitary component can include cross-chain polymerization between the portions constituting the unitary component. Similarly, as used herein, portions can be “integrally formed,” or one portion can be “integrally formed” with a different portion, resulting in a unitary component differing from a laminate or assembly of differing constituents, which includes an interface between differing constituents thereof.

The term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The term “coupled” is defined as connected, although not necessarily directly, and not necessarily mechanically; two items that are “coupled” can be unitary with each other. The terms “a” and “an” are defined as one or more unless this disclosure explicitly requires otherwise. For example, “an element” has the same meaning as “at least one element,” unless the context clearly indicates otherwise. The term “combination” is inclusive of blends, mixtures, alloys, reaction products, and the like. Also, “at least one of” means that the list is inclusive of each element individually, as well as combinations of two or more elements of the list, and combinations of at least one element of the list with like elements not named. “Or” means “and/or.” The suffix “(s)” as used herein is intended to include both the singular and the plural of the term that it modifies, thereby including one or more of that term (e.g., the film(s) includes one or more films).

1. A cover for a battery pack for an electrical vehicle, comprising:
a cover base portion defining an edge perimeter sized to cover an opening of a housing subcomponent of the battery pack, the cover base portion comprising a plurality of cover fastening features proximal to the edge perimeter defining a cover fastening perimeter; and
a battery divider protruding from the cover base portion and extending past a plane generally defined by the cover fastening perimeter, the battery divider formed by a plurality of walls, the plurality of walls defining a cover hollow that extends from a cover hollow base proximal the cover base portion to a cover hollow distal portion of the battery divider, defining a distal opening that opens away from the cover hollow base,
wherein the cover base portion and the battery divider are formed of a cover thermoplastic monolith.

2. The cover of claim 1, wherein the plurality of walls are adapted to physically secure at least one module of the battery pack against a housing subcomponent of the battery pack mateable to the cover.

3. The cover of claim 1, wherein the cover is a top cover to cover battery modules disposed in a housing subcomponent mateable to the cover, wherein the top cover has a bending stress that is lower than the housing subcomponent.

4. The cover of claim 1, wherein the cover base portion is planar.

5. The cover of claim 1, wherein a cross-section of the battery divider taken generally perpendicular to the plane is trapezoidal, with the battery divider defining a battery divider base portion proximal the cover base portion that is wider than a battery divider tip distal to the battery divider base portion.

6. The cover of claim 1, wherein the cover includes one or more ribs disposed in the cover hollow to support the plurality of walls, wherein the cover is an injection molded thermoplastic monolith.

7. The cover of claim 1, wherein the battery divider is smooth along an outer surface opposite the cover hollow.

8. The cover of claim 1, wherein the cover defines a lip proximal the edge perimeter, interior to the cover fastening perimeter.

9. The cover of claim 1, wherein the cover defines a plurality of battery module locating features to constrain a plurality of battery modules with respect to the cover.

10. A cover for a battery pack for an electrical vehicle, comprising:
a cover base portion defining an edge perimeter sized to cover an opening of a housing subcomponent of the battery pack, the cover base portion comprising a plurality of cover fastening features proximal to the edge perimeter defining a cover fastening perimeter; and
a means for separating battery pack components, the means protruding from the cover base portion and for extending through a housing subcomponent, mateable to the cover, to a bottom floor of the housing subcomponent, wherein the means for separating battery pack components are also for defining an air gap between two battery pack components,
wherein the means for separating battery pack components are hollow, and
wherein the cover base portion and the means for separating battery pack components comprising a single mold of thermoplastic.

11. The cover of claim 10, wherein the means for separating battery pack components are for wedging between two battery pack components and for pressing them against a housing subcomponent mateable to the cover.

12. The cover of claim 10, wherein means for separating battery pack components are for physically securing at least one module of the battery pack against a housing subcomponent of the battery pack.

13. The cover of claim 10, comprising battery locating means formed on the cover for constraining a plurality of battery modules with respect to the cover.

14. The cover of claim 10, wherein the means for separating battery pack components are for defining a cover hollow, with the cover comprising rib means disposed in the cover hollow.

15. The cover of claim 10, comprising lip means for locating the cover with respect to a housing subcomponent mateable to the cover, for aligning cover fastener passages and housing subcomponent passages.
